(19) United States
(12) Patent Application Publication
(10) Pub. No.: US 2014/0361465 A1
(43) Pub. Date: Dec. 11, 2014

(54) Method for Recycling Furniture, in Particular Bed Bases, Web of Material Obtained by Such A Method, and Associated Recycling Installation

(71) Applicants: Remy Lanza, Bollene (FR); Salim Touati, Livron Sur Drome (FR)

(72) Inventors: Remy Lanza, Bollene (FR); Salim Touati, Livron Sur Drome (FR)

(73) Assignee: Ecoval Environnement, Lognes (FR)

(21) Appl. No.: 13/812,963

(22) PCT Filed: Jul. 26, 2011
(86) PCT No.: PCT/FR2011/051796

§ 371 Date: Apr. 4, 2013

(30) Foreign Application Priority Data
Jul. 29, 2010 (FR) 10 56248

(51) Int. Cl. B27N 3/26; B27N 3/02; B27N 3/00; B27N 1/00; B27N 1/02

(52) U.S. Cl. CPC B27N 3/26; B27N 1/00; B27N 1/02; B27N 3/007; B27N 3/02
USPC 264/460; 264/123; 264/121; 425/202

(57) ABSTRACT

The invention relates to a method for recycling furniture containing wooden parts, in particular bed bases, the method comprising the following steps:

a step (20) of grinding the wooden parts to form ground wood;

a mixing step (22) in which a mixture is prepared, the mixture comprising a predetermined quantity of bi-component fibers;

a step (24) of forming a non-consolidated web of material from the mixture;

a step (26) of thermally consolidating the non-consolidated web of material;

a step (27) of calendering the consolidated web of material.

The present invention generally relates to the field of furniture.

More specifically, according to a first aspect, the invention relates to a method for recycling furniture comprising wooden parts, in particular bed bases.

At the end of their life, bed bases are taken to the dump or incinerated. These solutions are not satisfactory from an ecological perspective. End-of-life bed bases make up a very significant flow each year. They are made up of materials very different from one another, such as steel, wood, textiles, polyurethane foams, etc. Incinerating these materials causes gas discharges, some of which may be toxic. When the bed bases are taken to the dump, they take up a significant amount of space and are poorly suited to the existing treatment channels. Furthermore, some materials are not biodegradable over time.

In this context, the invention aims to propose a method for recycling furniture that is more ecologically satisfactory than taking it to a dump or incinerating it.

To that end, the invention relates to a method for recycling furniture containing wooden parts, in particular bed bases, the method comprising the following steps:

a step of grinding the wooden parts to form ground wood;
a mixing step, during which a mixture is prepared, the mixture comprising a predetermined quantity of ground wood and a predetermined quantity of bi-component fibers;
a step for forming a ply of unconsolidated material from the mixture;
a step for thermal consolidation of the ply of unconsolidated material;
a step for calendering the ply of consolidated material.

The method may also include one or more of the following features, considered individually or according to any allowable combinations:

a disassembly step, in which base materials are obtained by disassembling furniture;

a sorting step, in which the wooden parts are separated from the base materials;

in the grinding step, the furniture is ground whole, without prior disassembly;

a step for disinfecting the furniture, before the grinding step;

the furniture is disinfected chemically by spraying a disinfectant on an outer surface of the furniture, or by exposing the furniture to microwave radiation;

in the step for forming the ply of unconsolidated material, the mixture is driven and dispersed by a flow of air in the chamber, according to the air lay method;

before the grinding step, a step for detecting a plurality of predetermined chemical compounds in the furniture;

the mixture comprises between 50 wt % and 95 wt % ground wood, and between 5 wt % and 50 wt % bi-component fibers;

the wooden parts are ground into shavings with a length of between 10 and 20 mm and a width comprised between 2 and 5 mm.

According to a second aspect, the invention relates to a ply of material obtained using a method having the above characteristics, the ply including a mixture of bi-component fibers and ground wood.

Preferably, said mixture can comprise between 50 wt % and 95 wt % of ground wood, and between 5 wt % and 50 wt % of bi-component fibers.

According to a third aspect, the invention relates to a facility for recycling furniture, in particular be dbases, which comprises:

a device for grinding wooden parts;

a mixing device, in which a mixture is prepared, the mixture comprising a predetermined quantity of ground wood and a predetermined quantity of bi-component fibers;

a device for forming a ply of unconsolidated material from the mixture;

a device for thermal consolidation of the ply of unconsolidated material;

a device for calendering the ply of consolidated material.

Other features and advantages of the invention will emerge from the detailed description thereof provided below, for information and non-limitingly, in reference to the appended figures, in which:

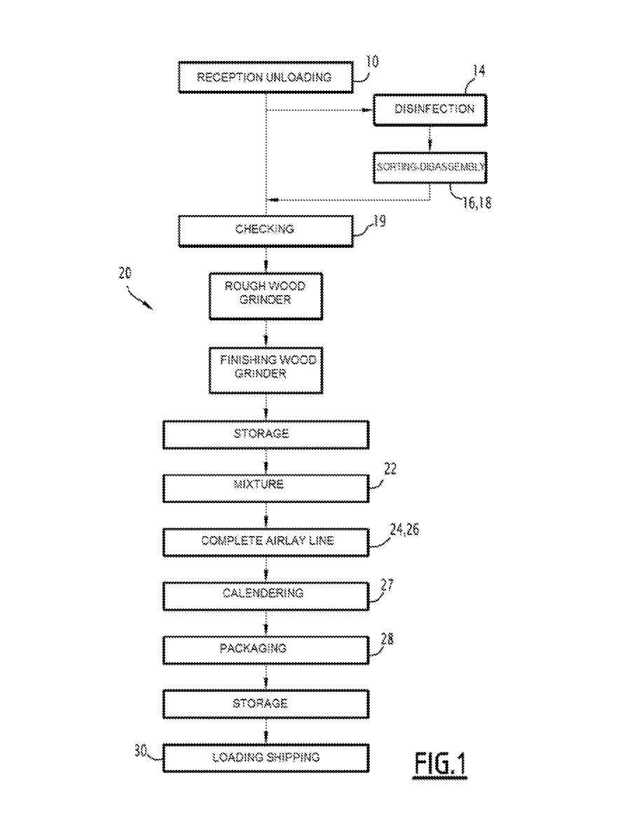

FIG. 1 is a flowchart, illustrating the method according to the invention;

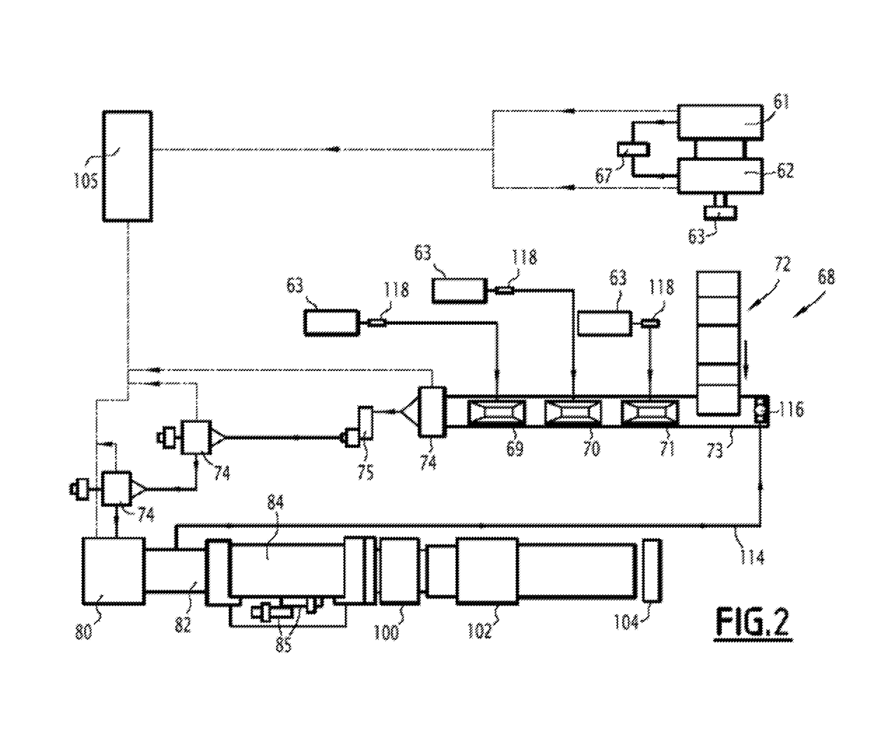

FIG. 2 is a simplified diagrammatic illustration of the production lines for the grinding, mixing, unconsolidated ply formation and consolidation steps;

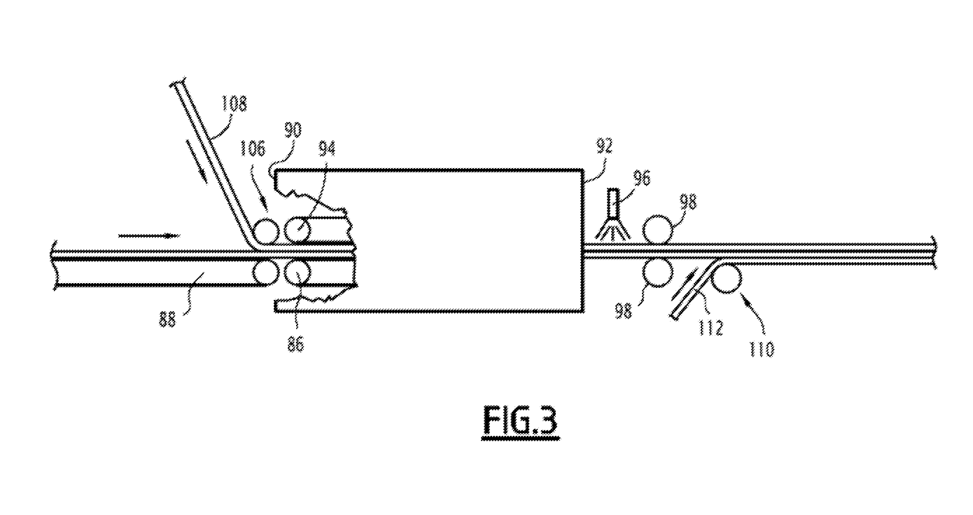

FIG. 3 is a simplified diagrammatic illustration of the consolidation step of the ply of unconsolidated materials.

The method that will be described below, the primary steps of which are diagrammatically illustrated in FIG. 1, is designed to recycle end-of-life furniture.

This furniture is, inter alia, bed frames, sideboards, closets, wardrobes, cupboards, and any other type of furniture including wooden parts. Furniture here refers both to complete furniture including all of its parts (doors, side and rear panels, bottom, intermediate shelves, etc.), and isolated furniture items that do not form a complete piece of furniture by themselves (a door, panel, etc.). The method is also suitable for recycling manufacturing scraps containing wood, for example manufacturing scraps from bed frames or furniture, in addition to the furniture or furniture items.

In the following description, “item to be treated” will refer to complete furniture and manufacturing scraps.

All of the recycled furniture includes wooden parts. It may be made up entirely of wooden parts, or on the contrary include both wooden parts and parts made from another material (fabrics, plastic, metal, etc.). The wooden parts may be bare, painted, dyed, covered with a decorative coating made from plastic or fabric, etc.

The wooden parts may be solid wood, for example such as pine, oak, cherry, pear tree, etc.

The wooden parts may also be made from pressed wood. Pressed wood refers to parts made from wooden particles (fibers, shavings, fragments), assembled using a binder such as a glue. These parts may be assembled under pressure and a high temperature. Glulam, average density fiber panels, counterveneer and oriented strandboards are examples of pressed wood, this list not being exhaustive.

As illustrated in FIG. 1, the method includes the following steps:

a step 10 for receiving and unloading the items to be treated;

a step 14 for disinfecting the items to be treated;

a disassembly step 16, in which the base materials are obtained by disassembling the items to be treated;

a sorting step 18, in which the wooden parts are separated from the base materials;

a checking step 19, aiming to detect a plurality of predetermined chemical compounds in said wooden parts;

a step 20 for grinding wooden parts to form ground wood;

a mixing step 22, in which a mixture is prepared, the mixture comprising a predetermined quantity of shredded wood and a predetermined quantity of bi-component fibers;

a step 24 forming a ply of unconsolidated material from the mixture;

a step 26 for consolidating the ply of unconsolidated material;

a step 27 for calendering the consolidated material ply;

a step 28 for packaging the ply of consolidated material and a step 30 for loading and shipping the ply of consolidated material.

These different steps will now be outlined in turn.

In step 10, the items to be treated or received and unloaded from the transport means.

Some of the items to be treated at the end of life, for example used bed bases, are then oriented toward the disinfecting step 14. Other items are sent directly to the disassembly 16 and sorting 18 steps or the checking step 19, without going through the disinfection step 14.

The purpose of the disinfection step is to destroy the bacteriological germs that may be present in the items to be treated. The disinfection must be sufficient from a sanitary perspective to protect the operators working at the various steps of the method, and to guarantee complete hygiene of the recycled finished products.

The disinfection step is not a sterilization step and does not aim to destroy all of the germs present in the items to be treated.

The disinfection step aims to eliminate at least 99% of bacteriological germs, preferably at least 99.9% of bacteriological germs, and still more preferably at least 99.99% of bacteriological germs.

The disinfection step is done either chemically or using electromagnetic waves.

The chemical disinfection consists of spraying a disinfectant on the outer surface of the items to be treated. This operation is carried out in a hermetic chamber. After spraying, the item to be treated remains in the chamber for approximately 2 h 30.

The disinfectant is for example the product bearing commercial name ANIOS DVA HPH sold by the laboratory ANIOS. The quantity of product used is approximately 8 mL for a normal size bed base.

Disinfection using electromagnetic waves is done by placing the element to be treated in a microwave tunnel.

In the disassembly step 16, the items to be treated are disassembled by operators.

In the sorting step, the wooden parts are separated from the other materials obtained by disassembling the items to be treated.

For example, the bed bases generally include a rigid frame made from wood or metal, and may include wood slats, a textile enclosure, metal spiral springs, etc.

The wood structures of the bed bases (frames, slats) are separated from the textile enclosures and the metal springs.

It is also possible to separate the wooden parts from one another, by sorting them into difference families depending on the nature of the wood (pressed or solid wood), the essence of the wood in the case of solid wood, the type of pressed wood, etc.

In step 19, the composition of certain materials is checked. These materials are those likely to contain chemical compounds that are not authorized in the finished product. These chemical compounds are for example VOCs (Volatile Organic Compounds), such as formaldehyde. The materials likely to contain such chemical compounds are for example pressed wood panels, polyurethane foams, adhesive residues, etc.

The check is done by removing a small quantity of each material to be checked, and analyzing the composition of that sample in an automatic detection device to verify whether the sample contains a chemical compound appearing in a predetermined list. This device may for example be a gas-phase chromatography device coupled with an FID (Flame Ionization Detector).

If the material contains a chemical compound from the list, in a quantity below a predetermined threshold, that material is treated using the recycling method. The grinding and consolidation steps 20 and 26 in fact make it possible to eliminate a significant fraction of the chemical compound, and to make the concentration of said chemical compound in the consolidated nonwoven product ply be within the acceptable standards. The consolidation step uses thermal treatment, as explained later, and is particularly effective to eliminate regulated chemical compounds. The predetermined threshold is specific to each chemical compound. It depends, inter alia, on the removal rate of the chemical compound in the grinding and consolidation steps, and the composition of the nonwoven material ply (proportion of the material containing the chemical compound in the ply).

If the material contains a quantity of the chemical compound above the predetermined threshold, then that material is not treated using the recycling method. It is for example sent to a controlled dump, provided to accept materials containing the detected chemical compound.

In step 20, the wooden parts are ground into shavings with a length comprised between 10 and 20 mm and a width comprised between 2 and 5 mm. The grinding operation is performed in two stages. The materials are first treated in a rotor preform shredder, with a 30 to 50 mm hopper. The materials from the preform shredder then go through a secondary shredder, equipped with a 4 mm to 10 mm hopper. The shavings are collected in bags.

Vibrating separators equipped with magnetic rollers are placed immediately downstream of each shredder. They make it possible to separate the metal parts from the other ground materials.

Alternatively, it is possible to grind the items to be treated without prior disassembly. In that case, the metals are separated from the other materials using magnetic rollers. However, the ground wood leaving the shredders then contains not only wood, but also other materials such as the textile trim of bed bases.

The different families of wooden parts can be ground separately.

At the end of the grinding step 20, the ground wood is stored, for example in bags. The different families of wooden parts can be stored in separate bags.

It should be noted that the grinding step causes the partial elimination of certain chemical compounds, for example VOCs or formaldehyde. These compounds are for example released in gaseous form.

In step 22, a mixture is prepared from ground wood. A predetermined quantity of ground wood is mixed with a predetermined quantity of bi-component fibers, those quantities being selected according to the final product to be obtained.

This bi-component fiber is designed, after heating, to consolidate the ply of materials, as described below.

Alternatively, other materials may be added to the mixture, these materials not resulting from furniture recycling. It is also possible to add additives to the mixture that are selected according to the nature of the finished product. For example, the additives may include a fireproofing product, etc.

According to one example embodiment, the finished product is a ply of a wood-based thermoformable material, with a thickness comprised between 5 and 50 mm, for example 10 mm thick.

For such a finished product, a mixture is chosen that comprises, by weight:

between 50% and 95% of ground wood, preferably between 65% and 90% of the fourth family of ground wood, and still more preferably between 75% and 85% ground wood;

between 5 and 50% bi-component fibers, preferably between 10 and 35% bi-component fibers, and still more preferably between 15% and 25% bi-components.

The bi-component fibers are made up of two components distributed over the entire length of the fiber. Each component may have different physical or chemical properties. The components may also either be alternatives of a same type of polymer, or two completely different types of polymer. One example of such a fiber is marketed by the company MAX MODEL SA under the name “Polyester staple fiber, low melt 4/51 mm 110° C. flame retardant ref 4140.” The use of other thermofusible components may also be considered.

In step 24, a ply of unconsolidated material is formed from the mixture, typically according to the “airway” method. This method consists of forming a ply of material similar to a nonwoven material by dispersing the mixture in a high velocity air current, and depositing the mixture transported by the air current in a chamber. The air current may be created by an excess pressure upstream of the chamber or by a reduced pressure downstream of the chamber.

Before going on to the step 24 for forming the ply, the mixture can go into one or more openers, which each comprise one or more rotary rollers provided with spurs. The primary function of these rollers is to route the textile parts if the mixture contains any, so as to separate the textiles and open the fibers. The rollers also make it possible to mix the different materials of the mixture, and to homogenize that mixture.

At the end of step 24, the materials making up the ply are not yet bound to each other and are arranged in bulk on a belt.

In step 26, a ply of material is consolidated. This consolidation is done through thermal treatment. The ply of unconsolidated material is heated in a furnace, for example at a temperature of approximately 180° C. The thermal treatment causes partial fusion of the bi-component fibers, which contributes to binding the various components of the mixture to each other (wood shavings, bi-component fibers). This thermal treatment also causes the elimination of certain chemical compounds, for example the VOCs. These compounds may be broken down thermally, or may be released in gas form.

Concomitantly with the thermal treatment operation, it is possible to deposit a coating layer on the ply of material. It is possible to associate all sorts of layers: fabric layers, leather layers, decorative plastic layers, etc. The two surfaces of the ply may thus be covered. Preferably, one of the surfaces is covered upstream of the thermal treatment step, the other immediately downstream of the thermal treatment step.

After the thermal treatment step 26, the ply can go on to a cutting step, to form pieces with dimensions suitable for their final use. Alternatively, the ply may not be cut, but wound and stored in the form of a roll (packaging step 28).

Lastly, the ply is loaded and shipped, either in the form of a roll, or in the form of already-cut pieces (step 30).

The recycling facility will now be described. It is provided to carry out the above method.

The grinding operation of the wooden parts is carried out in two stages. The wooden parts are first treated in a rotor preform shredder 61, of the WAGNER brand and type WS70, with a 30 to 50 mm hopper. The materials coming from the preform shredder then go through a secondary shredder 62, for example Wagner brand and type WS30, equipped with a hopper of 4 to 10 4 mm. The shavings are collected in bags 63.

The vibrating separators equipped with magnetic rollers, placed immediately downstream of the shredder, are not shown.

When the items to be treated are ground whole, without disassembly, the same shredders and the same separators are used.

The ground wood is stored in bags 63 and the metal parts separated from the wood in tubs or movable containers 67.

The mixing device 68 is shown diagrammatically in FIG. 3. The device 68 comprises:

for example, three assay devices 69, 70, 71, for instance each dedicated to a different family of wooden parts;

a device 72 for assaying bi-component fibers;

a conveyor 73 supplied by the assay devices 69, 70, 71 and 72;

at least one opener 74, provided to mix the materials brought in by the conveyor 73;

a device 75 for adding additives.

The assay devices 69, 70, 71 are silos, each having an inner volume provided to receive a quantity of the ground wood, respectively. Each silo 69, 70, 71 is equipped with sensors suitable for measuring the ground wood loaded inside the inner volume.

The mixing device 68 has a suction unit 118 for each silo, provided to suction shavings of ground wood from bags 63 and transfer them to the corresponding silo.

The lower portion of each silo 69, 70, 71 is equipped with an outlet situated overhanging the conveyor 73. Each of the silos is equipped with a control valve, making it possible to open and close the outlet selectively.

The bi-component fibers assume the form of a block of fibrous material. The device 72 dedicated to assaying the bi-component fibers includes a tool provided to nibble the block of bi-component fibers and produce shavings, a cell for weighing the fibers, and a transfer member from the weighing cell to the conveyor 73.

The nibbling tool may be of any suitable type, and for example includes a plurality of tips.

The shavings detached by the nibbling tool are transferred to the weighing cell, for example by a conveyor belt. They are transported from the weighing cell to the conveyor 73 by a chute or another conveyor belt.

In the example embodiment shown in FIG. 3, the device 68 includes three openers 74 placed serially. The materials deposited on the conveyor 73, at the end of said conveyor, are poured into the first opener 74.

The three openers 74 are of the same type.

The device 75 is for example inserted between the first and second openers 74. It is provided to add a mixture of additives selected according to the nature of the finished product. For example, the additives may include a fireproofing product, an insecticide, etc.

The openers 74 and the device 75 are connected to each other by connecting ducts. The mixture is transferred along the ducts by pulsed air.

The device for forming the ply of unconsolidated materials and the thermal treatment device are shown diagrammatically in FIG. 3. The device 80 for forming the ply is of the type described in Italian patent application no. PO2007/A000021. This device includes two vacuum chambers, and is particularly well suited to treating a mixture containing a high proportion of wood shavings.

The last opener 74 is connected to the device for forming the ply 80 by a duct. The mixture is transferred along the duct, for example by pulsed air.

The ply 82 leaving the device 80 is transported on a conveyor and penetrates the furnace 84 to undergo the thermal treatment therein. The furnace for example has a total length of 5 m, and is divided into two chambers placed serially with one another. It is heated by gas burners 85. It is equipped with fans to allow the circulation of the heated air through the burners inside the two chambers. The device is equipped with two conveyors placed inside the furnace 84, as shown in FIG. 4. The lower conveyor 86 is placed in the extension of the conveyor 88, which ensures transportation of the ply from the device for forming the ply 80 to the furnace 84. The conveyor 86 transports the ply through the furnace 84 from the inlet 90 to the outlet 92. The upper conveyor 94 is placed above the conveyor 86. The vertical spacing of the conveyor 94 relative to the conveyor 86 is adjustable, such that the conveyor 94 calibrates the thickness of the ply 82 at the inlet of the furnace. The conveyor 94 extend substantially over the entire length of the furnace, from the inlet 90 to the outlet 92.

The ply 82 undergoes cooling upon leaving the furnace 84, first through a projection of cold air using nozzles 96, then by calendering using cooled rollers 98. Downstream of the calendering rollers 98, a device 100 (FIG. 3) can be placed capable of routing the ply 82 either toward a cutting unit 102 or toward a storage roller 104.

As shown in FIG. 4, the thermal treatment device may also include an assembly 106 making it possible to eliminate a coating layer 108 on one of the surfaces of the ply 82, here the upper surface. The assembly 106 is placed immediately upstream of the furnace 84. A similar assembly 110 is placed downstream of the calendering rollers 98, so as to eliminate another coating layer 112 on the opposite surface of the ply 82, here the lower surface.

The device also allows cold calendering of the ply, which is a mechanical operation designed to stabilize and fix the desired thickness of the ply, which is obtained according to the degree of calendering (cooling pressure and temperature) through which the ply undergoes a thermal shock. It may serve as a flow regulator and degasser for the air and/or volatile materials present from upstream in the process.

As visible in FIG. 3, the scraps of material coming from the device for forming the ply 80 are collected and sent back via the line 114 to the conveyor 73. After grinding in a shredder 116, these materials are recycled on said conveyor 73.

The recycling facility is also equipped with a centralized ventilation device 105, provided with air extractors suitable for suctioning the air in the primary equipment of the facility: the shredders 61 and 62, the silos 69 to 71, the openers 74, the device 80 for forming the ply. The dusts are trapped on a filter, for example a bag filter. They may be reused, for example in road covering products.

The finished product is a ply of a wood-based thermoformable material, with a thickness comprised between 5 and 15 mm, for example 10 mm thick.

The finished product comprises, by weight:

between 50% and 95% wood, preferably between 65% and 90% wood, for example between 75% and 85% wood;

between 5% and 50% of bi-component fibers, preferably between 10% and 35% of bi-component fibers, for example between 15% and 25% of bi-component fibers.

For example, the consolidated ply comprises 80 wt % wood and 20 wt % of bi-component fibers.

The plies obtained using the above method may be used for many applications.

In particular, they may be used for furniture, and are particularly well suited for undergoing thermoforming operations.

The plies described above may also be manufactured from materials that do not result from recycling bedding or furniture items or manufacturing scraps. The materials may be raw materials directly acquired from manufacturers, specifically to produce the plies.

1. A method for recycling furniture containing wooden parts, in particular bed bases, the method comprising the following steps:
a step (20) of grinding the wooden parts to form ground wood;
a mixing step (22), during which a mixture is prepared, the mixture comprising a predetermined quantity of ground wood and a predetermined quantity of bi-component fibers;
a step (24) for forming a ply of unconsolidated material from the mixture;
a step (26) for thermal consolidation of the ply of unconsolidated material;
a step (27) for calendering the ply of consolidated material.

2. The method according to claim 1, characterized in that it comprises:
a disassembly step (16), in which base materials are obtained by disassembling furniture;
a sorting step (18), in which the wooden parts are separated from the base materials.

3. The method according to claim 1, characterized in that, in the grinding step (20), the furniture is ground whole, without prior disassembly.

4. The method according to claim 1, characterized in that it comprises a step (14) for disinfecting the furniture, before the grinding step (20).

5. The method according to claim 4, characterized in that the furniture is disinfected chemically by spraying a disinfectant on an outer surface of the furniture, or by exposing the furniture to microwave radiation.

6. The method according to claim, characterized in that, in the step (24) for forming the ply of unconsolidated material, the mixture is driven and dispersed by a flow of air in the chamber, according to the air lay method.

7. The method according to claim 1, characterized in that it comprises, before the grinding step (20), a step for detecting a plurality of predetermined chemical compounds in the furniture.

8. The method according to claim 1, characterized in that the mixture comprises between 50 wt % and 95 wt % ground wood, and between 5 wt % and 50 wt % bi-component fibers.

9. The method according to claim 1, characterized in that the wooden parts are ground into shavings with a length of between 10 and 20 mm and a width comprised between 2 and 5 mm.

10. A ply of material obtained using a method according to claim 1, the ply including a mixture of bi-component fibers and ground wood.

11. The ply according to claim 10, characterized in that said mixture can comprise between 50 wt % and 95 wt % of ground wood, and between 5 wt % and 50 wt % of bi-component fibers.

12. A facility for recycling furniture, in particular bed bases, the facility comprising:
a device (58, 59, 60) for grinding wooden parts;
a mixing device (68), in which a mixture is prepared, the mixture comprising a predetermined quantity of ground wood and a predetermined quantity of bi-component fibers;
a device (80) for forming a ply of unconsolidated material from the mixture;
a device (84) for thermal consolidation of the ply of unconsolidated material;
a device for calendering the ply of consolidated material.
